(19) United States
(12) Patent Application Publication
(10) Pub. No.: US 2019/0143266 A1
(43) Pub. Date: May 16, 2019

(54) BIOLOGICAL TREATMENT OF FLUE GAS DESULFURIZATION BLOWDOWN WATER WITH UPSTREAM SULFITE CONTROL

(71) Applicant: BL Technologies, Inc., Minnetonka, MN (US)

(72) Inventors: Trevor James Dale, Metuchen, NJ (US); Raymond Raulfs Gansley, Knoxville, TN (US); Joel Alexander Citulski, Oakville (CA)

(21) Appl. No.: 16/098,270

(22) PCT Filed: May 10, 2017
(86) PCT No.: PCT/US17/31952

§ 371 Date: Nov. 1, 2018

Related U.S. Application Data
(63) Continuation of application No. 15/151,536, filed on May 11, 2016.

(51) Int. Cl. B01D 53/73; B01D 53/50; B01D 53/80; B01D 53/64; C02F 3/28; C02F 1/00; B01D 53/34; C02F 1/74; C02F 1/52

(52) U.S. Cl. CPC B01D 53/73; B01D 53/501; B01D 53/80; B01D 53/64; C02F 3/2826; C02F 1/004; C02F 2103/18; C02F 1/74; C02F 1/5236; C02F 1/008; B01D 53/504; C02F 1/5245; C02F 1/52; B01D 53/346

(57) ABSTRACT

Systems and methods are described for treating flue gas, for example from a coal fired power plant. The systems and methods include control of a wet flue gas desulfurization (WFGD) system to manage sulfite concentration in a slurry produced by the WFGD system. Oxygen is added to the slurry in an amount sufficient to produce a sulfite concentration in the slurry in the range of about 5 to 75 mg/L, an oxidation reduction potential in the range of about 100-250 mV, or both. The systems and methods also include the biological treatment to remove selenium from a liquid fraction of the slurry. The liquid fraction is treated in a biological reactor maintained under anoxic or anaerobic conditions to reduce its selenium concentration.

### CROSS-REFERENCE TO RELATED APPLICATIONS

This application is a continuation-in-part of U.S. application Ser. No. 15/151,536, filed May 11, 2016. U.S. application Ser. No. 15/151,536 is incorporated by reference.

### TECHNICAL FIELD

This specification relates to treating flue gas for example from a coal fired power plant wherein the treatment includes the biological treatment to remove selenium from blowdown from a wet flue gas desulfurization system.

### BACKGROUND OF THE INVENTION

Combustion of fuel sources such as coal produces a waste gas, referred to as a “flue gas” that is to be emitted into an environment, such as the atmosphere. The fuel sources typically contain sulfur and sulfur compounds that are converted in the combustion process to gaseous species, including sulfur oxides, in the resulting flue gas. The fuel sources typically also contain elemental mercury or mercury compounds that are converted in the combustion process and exist in the flue gas as gaseous elemental mercury or gaseous ionic mercury species.

As such, the flue gas contains particles, noxious substances, and other impurities considered to be environmental contaminants. Prior to emission into the atmosphere via a smoke stack, the flue gas undergoes a cleansing or purification process. In coal combustion, one aspect of this purification process is normally a desulfurization system, such as a wet scrubbing operation commonly known as a wet flue gas desulfurization system.

Sulfur oxides are removed from the flue gas using the wet flue gas desulfurization system by introducing an aqueous alkaline slurry to a scrubber tower. The aqueous alkaline slurry typically includes a basic material that will interact with contaminants to remove them from the flue gas. Examples of basic materials that are useful in the aqueous alkaline slurry include lime, limestone, magnesium salts, sodium hydroxide, sodium carbonate, ammonia, combinations thereof and the like.

International Publication Number WO 2007/012181 describes an apparatus and method for treating flue gas desulfurization (FGD) blowdown water. The process includes steps of anoxic or anaerobic treatment to denitrify the blowdown and remove soluble selenium species.

### SUMMARY OF THE INVENTION

This specification describes systems and methods for treating flue gas. The systems and methods include control of a wet flue gas desulfurization (WFGD) system to manage sulfite concentration in a slurry produced by the WFGD system. The systems and methods also include the biological treatment to remove selenium from a liquid fraction of the slurry.

In some examples, the specification describes a method of treating a slurry produced during desulfurization of a flue gas. Oxygen is added to the slurry in an amount sufficient to produce a sulfite concentration in the slurry in the range of about 5 to 75 mg/L, an oxidation reduction potential in the range of about 100-250 mV, or both. A liquid fraction is separated from the slurry. The liquid fraction is treated in a biological reactor maintained under anoxic or anaerobic conditions to reduce its selenium concentration.

In some examples, the specification describes a system for treating a wet flue gas desulfurization slurry. The treatment system includes a sulfite detector, controller and aerator configured to control the concentration of sulfite in the slurry. The treatment system also includes an anoxic or anaerobic biological reactor that receives a liquid fraction of the slurry.

### BRIEF DESCRIPTION OF THE DRAWINGS

FIG. 1 is a schematic diagram of a waste water preconditioning system as may be described herein with a wet flue gas desulfurization system and a waste water treatment system.

FIG. 2 is a schematic diagram of the wet flue gas desulfurization system of FIG. 1.

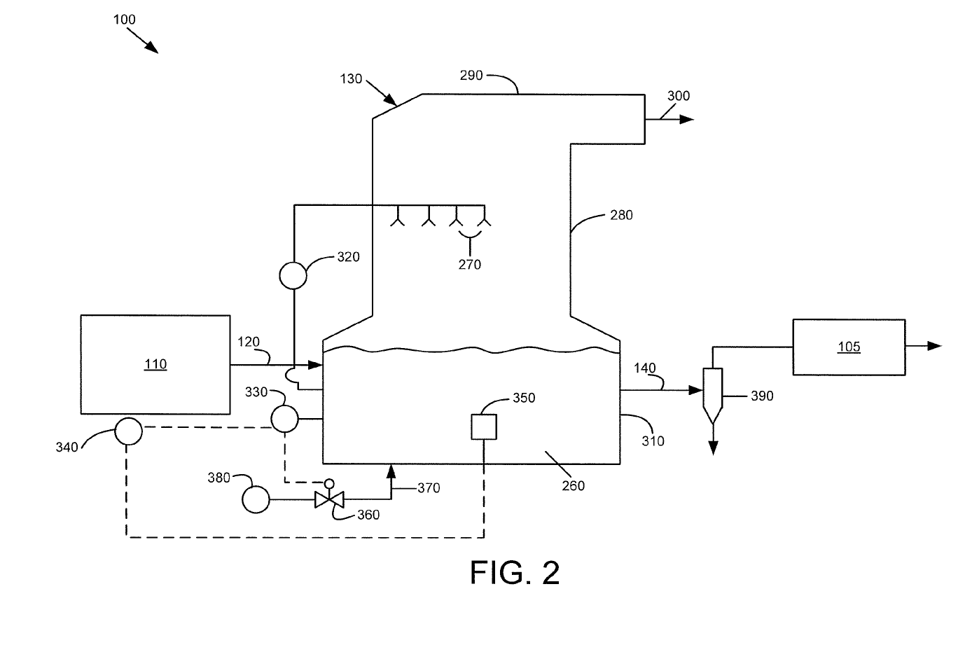

### DETAILED DESCRIPTION

Coal-fired power plants produce a flue gas containing sulfur compounds. The flue gas is often cleaned in a wet flue gas desulfurization (WFGD) system before it is exhausted from the plant. In a typical WFGD system there is a tank containing an alkaline slurry. A bleed from the slurry tank is separated to produce a solids fraction and a liquid fraction. The liquid fraction of the slurry is recirculated through a flue gas scrubber. Various pollutants collect in the slurry as the recirculated liquid fraction is contacted with flue gas in the scrubber and returns to the slurry tank. It is common to add oxygen, for example as air, to the slurry tank to oxidize sulfites in the slurry. The added oxygen helps create calcium sulfate, a useable gypsum byproduct, in the solids fraction. The concentration of various components of the slurry can vary due to plant operating parameters, coal source, and the degree of oxidation in the slurry tank.

Oxidation reduction potential (ORP) is a measure of relative chemical oxidative or reductive potential of a liquid such as the slurry. With aeration in the slurry tank at a constant rate, ORP in the slurry can fluctuate over a large range, for example from less than 100 mV to greater than 600 mV, sometimes in less than an hour. The high ORP of the slurry can be caused by (1) oxidant compounds produced in the flue gas as chloride and bromide (either natively occurring in the coal or added in the form of combustion agents such as CaBr₂) become oxidized to compounds such as hypochlorous/hypobromous acid; and/or (2) oxidizer production in the slurry tank itself as sulfur becomes oxidized to compounds such as dithionate (S₂O₆²⁻) or peroxydisulfate (S₂O₈²⁻⁻) by air added in the slurry tank. The amount of oxidizers present in the WFGD slurry is often reported as a “chlorine-equivalent” concentration, frequently as measured using an iodine/thiosulfate titration test. At elevated ORP (i.e. more than +200 mV), the slurry may have a chlorine-equivalent concentration of up to 200 mg/L.

A portion of the liquid fraction of the slurry is removed from the WFGD system in a blowdown stream. The blowdown contains suspended and soluble solids and is treated as wastewater. Treatment of the wastewater may include one or more of lime softening, chemical precipitation and solid-liquid separation. In one example, lime is added to the wastewater in an amount sufficient to produce a pH of 8.5 to 9 and the wastewater is aerated in a lime reaction tank. Optionally, an oxidant such as H₂O₂ or KMnO₄ may be added upstream of the lime reaction tank to oxidize As (III) to As (V). FeCL₃ and a polymeric flocculation aid are added to effluent from the aeration tank, which flows to a floculation tank. Soda ash is optionally added to the effluent from this tank, which flows to a solids contact clarifier for TSS and hardness removal. Effluent from the clarifier has an organo-sulfide and/or a specialized metal precipitant such as METCLEAR from General Electric added to it. The clarifier effluent then flows to a metals clarifier for As and Hg removal. Optionally, a single clarifier may be used for TSS, hardness, As and Hg removal. Sludge from the one or more clarifiers is thickened and dewatered to separate solids for disposal from liquid recirculated to the aeration tank for re-treatment.

After treatment steps as described above, the clarifier effluent may still contain various contaminants, such as nitrates and soluble selenium species, at least some of which may exceed discharge limits. In the systems and methods described herein, the wastewater (i.e. the clarifier effluent) is treated further in a biological reactor to remove, for example, soluble selenium species. In one example, selenium-reducing organisms are cultivated as an attached growth in a fixed bed reactor maintained under anoxic or anaerobic conditions. Since the WFGD blowdown typically contains nitrates, the fixed bed reactor may also contain denitrifying bacteria upstream of the selenium reducing bacteria. Alternatively or additionally, an upstream denitrification bioreactor of a different configuration (for example suspended growth or a moving bed attached growth) may be provided. Effluent from the bioreactor may be ready for discharge or may be polished further, for example in an aerobic bioreactor and/or with membrane filtration.

The one or more biological reactors to remove nitrate and/or selenium perform more consistently and reliably when there is a moderate and stable ORP level in the wastewater. Oxidizers in the WFGD blowdown can have a negative impact on downstream biological treatment processes at concentrations of 10 mg/L chlorine-equivalent or less, leading to decreased treatment efficacy and potentially partial or complete die-off of the biomass required for treatment. In the case of a bioreactor to remove nitrate and/or soluble species of selenium, for example a fixed bed anoxic or anaerobic bioreactor, the ORP of water flowing into the reactor is preferably reasonably stable and less than about +200 mV, less than about +150 mV, or less than abut +100 mV. Influent with higher ORP can be detrimental to populations of nitrogen and/or selenium reducing organisms.

A sulfite sensor in communication with the slurry can be used to vary the amount of air added to the slurry and produce a generally constant sulfite level in the slurry tank. This also decreases the variability of ORP in the slurry. One example of a commercially available sulfite sensor is the SULFITRAC sulfite analyzer from General Electric. When used with a controller to modify the slurry tank aeration rate, the sulfite sensor decreases the variability in the sulfite concentration and ORP of blowdown from the slurry tank.

In the apparatus and methods described herein, the efficacy of biological systems to remove wastewater contaminants such as nitrates and selenium is improved by reducing the variability of the WFGD wastewater stream compared to wastewater produced under constant rate aeration. In at least some cases, the amount of soluble selenium in the wastewater is reduced and/or the selenium speciation improved for biological treatment (i.e. the selenite to selenate ratio is increased) by the controlled aeration rate.

In the absence of sulfite monitoring and aeration control as described herein, the WFGD wastewater can be conditioned for biological treatment by treating it with a reducing agent upstream of the bioreactor. The reducing agent may be, for example, sodium bisulfite (SBS), sodium sulfite or potassium sulfite. The reducing agent can be mixed into wastewater flowing to a bioreactor, for example using an inline mixer. However, this method may not be adequately responsive to pulses of oxidizer in the wastewater and still fail to prevent negative impacts on the active biomass. Further, adding such a reducing agent increases the possibility of scale, for example gypsum or CaSO₄ scale, forming in the bioreactor. The precipitation and build-up of scale in the bioreactor, particularly a fixed bed reactor, can increase the resistance to flow through the reactor and interfere with biological activity. Optionally, an acid such as HCl can be mixed into the wastewater, or a sand filter or other separation device may be provided between the reducing agent mixer and the bioreactor, to help mitigate the increased scaling potential of the water. However, the reducing agent addition, acid addition and/or sand filter can be removed, or at least reduced, if the sulfite concentration in the slurry tank is controlled.

Optionally, aeration in the slurry tank can be controlled by reference to ORP measurements rather than sulfite measurements. An ORP sensor measures a bulk accumulation of electro-active species, which is not the concentration of any oxidants but is loosely correlated with total oxidant concentration measured as chlorine equivalent. About 80% of WFGD wastewater samples measured by the inventors that have ORP less than +200 mV also have less than 10 ppm oxidant as chlorine equivalent. A sulfite analyzer measures a specific oxidant that is relevant to the operation of the bioreactor and also, in combination with aeration control, produces wastewater with low ORP. In the context of a WFGD system with aeration control, an excess of sulfite in the slurry tank indicates that excess sulfur, which could be removed in the solids separated from the slurry by adjusting the aeration rate, is instead being carried over into the liquid fraction. An excess of sulfur compounds in the wastewater is undesirable since sulfide formation can compete with selenium reduction in the bioreactor and sulfur compounds can cause scaling in a fixed bed bioreactor. Aeration rate control with sulfite monitoring also reduces the concentration of soluble selenium in the WFGD wastewater. Since sulfite monitoring produces aeration rate responses that would satisfy an ORP monitoring process but that also help minimize total sulfur and selenium in the wastewater, sulfite monitoring is preferred over ORP monitoring. The inventors have also observed that the ORP response to a change in aeration rate lags behind the sulfite response both when aeration rate is increasing and when aeration rate is decreasing, suggesting that sulfite concentration measurements can improve the reaction time of the aeration control system compared to a control system using ORP measurements.

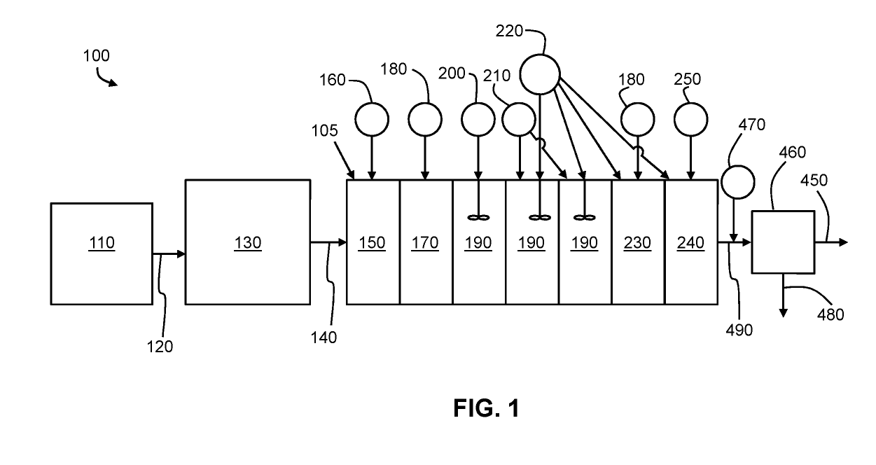

Referring now to the drawings, in which like numerals refer to like elements throughout the several views, FIG. 1 shows a schematic diagram of an example waste water preconditioning system 100. The waste water preconditioning system 100 may include a waste water treatment system (WWTS) 105. The WWTS 105 may be positioned downstream of a boiler 110 producing a flue gas 120 and a wet flue gas desulfurization system (WFGD) 130. The WFGD 130 may produce a flow of waste water 140, alternatively called blowdown, that should be processed before further use or disposal. Other components and other configurations may be used herein.

Generally described, the WWTS 105 may include a desaturator 150. The desaturator 150 treats the waste water 140 with a flow of lime 160 and the like so as to reduce the tendency of the waste water 140 to scale. The desaturator 150 reduces the concentration of sulfate therein by precipitation of calcium sulfate and the like. The WWTS 105 may include a primary clarifier 170 downstream of the desaturator 150. The primary clarifier 170 may remove suspended solids, including mercury, in the waste water 140. The primary clarifier 170 may add solidifiers 180 such as flocculants and other types of polymers to aid in the removal of solids and the like.

The WWTS 105 may include one or more mix tanks 190 downstream of the primary clarifier 170. The mix tanks 190 may mix pH adjusters 200, coagulators 210, metal precipitants 220, and other additives with the waste water 140. Specifically, certain types of metal precipitants 220 may be effective in reducing the levels of dissolved mercury in the waste water 140. An example of a metal precipitant 220 that may be used herein includes the METCLEAR metal precipitant offered by General Electric Company of Schenectady, New York. Other types of precipitants and other types of additives also may be used herein. The WWTS 105 also may include a further clarifier 230 and a number of filters 240. The further clarifier 230 largely functions in the same manner as the primary clarifier 170 described above. The filters 240 may have varying sizes and capacities to remove fine materials remaining in the waste water 140. The filters 240 may use a filter aid 250 and the like to improve filtration performance and/or a scale control agent to limit scaling. The WWTS 105 described herein is for the purpose of example only. Many different types of WWTS's and components and configurations thereof may be used herein.

Effluent 490 from the WWTS 105 flows to a bioreactor 460. Optionally, a reducing agent 470, for example, sodium bisulfite (SBS), sodium sulfite or potassium sulfite, may be added to the effluent 490, for example using an inline mixer. However, with sulfite monitoring and aeration rate control in the WFGD 130 as further described below, the amount of reducing agent 470 required can be reduced, or the reducing agent 470 may be eliminated.

The bioreactor 460 can include one or more anoxic or anaerobic reaction vessels. Preferably, at least one of the vessels includes a fixed media bed with an attached growth of selenium reducing organisms. The media may be granular activated carbon. Effluent 490 may flow upwards through the media bed. The selenium reducing organisms convert one or more soluble selenium species, such as selenite and selenate, to elemental selenium. The elemental selenium is removed from effluent 490 in a solid form that is retained by the media bed outside of or within the organisms. The bioreactor effluent 450 thereby has a reduced selenium concentration.

The media bed is backwashed periodically to remove the elemental selenium as a component of backwash sludge 480. The backwash sludge can be thickened and dewatered, optionally with one or more sludges produced in parts of the WWTS 105. Solids in the sludge 480 can be disposed of or processed to recover the selenium. Water separated from the sludge 480 can be returned to the WWTS 105 for further processing.

Optionally, nutrients can be added to effluent 490 flowing to the bioreactor 460 or between stages of the bioreactor 460. The bioreactor 460 may also remove nitrates and/or sulfur compounds. Nitrates can be removed in an upstream stage of bioreactor 460, which may be a fixed bed reactor or another type of reactor, for example a suspended growth or moving bed reactor. One suitable bioreactor 460 is the ABMET bioreactor available from General Electric, which is a fixed bed bioreactor suitable for removing nitrates and selenium. This and other sorts of bioreactor 460 are described in International Publication Number 2007/012181, which is incorporated herein by reference.

As described above, the WFGD system 130 may be positioned upstream of the WWTS 105 within the waste water preconditioning system 100. Within the WFGD system 130, the flue gas 120 may come into direct contact with an aqueous alkaline slurry 260 so as to remove contaminants therefrom. The aqueous alkaline slurry 260 may be introduced into the WFGD system 130 through one or more nozzles 270 in an upper portion 280 of a scrubber tower 290. The aqueous alkaline slurry 260 aids in removing contaminants such as sulfur oxides and mercury from the flue gas 120. The removal of such contaminants from the flue gas 120 produces a cleaned flue gas 300. The cleaned flue gas 300 flows out of the WFGD system 130 to a fluidly connected stack (not shown) or other type of emissions control apparatus (not shown). Although the WFGD system 130 is described herein as using the scrubber tower 290 for purposes of clarity, other types of WFGD systems also may be used herein.

The aqueous alkaline slurry 260 may be transported to the nozzles 270 from a collecting tank 310 via one or more pumps 320 and the like. The amount of aqueous alkaline slurry 260 transported to nozzles 270 may depend upon several factors such as, but not limited to, the amount of flue gas 120 present in the scrubber tower 290, the amount of contaminants in the flue gas 120, and/or the overall design of the WFGD system 130. After the aqueous alkaline slurry 260 directly contacts the flue gas 120 and removes the contaminants therefrom, the aqueous alkaline slurry 260 may be collected in the collecting tank 310 for recirculation to the nozzles 270 by the pumps 320.

One or more sulfite sensors 330 may be arranged in communication with the aqueous alkaline slurry 260 in the collecting tank 310. The sulfite sensors 330 may measure the sulfite concentration of the aqueous alkaline slurry 260 in the collecting tank 310. The sulfite sensors 330 may measure sulfite concentrations either continuously or at predetermined intervals. For example, predetermined intervals for sulfite concentration measurement may be determined automatically by a control device 340 in communication with the sulfite sensors 330 or manually by a user. The control device 340 may include, for example, but not limited to a computer, a microprocessor, an application specific integrated circuit, circuitry, or any other device capable of transmitting and receiving electrical signals from various sources, at least temporarily storing data indicated by signals, and perform mathematical and/or logical operations on the data indicated by such signals. The control device 340 may include or be connected to a monitor, a keyboard, or other type of user interface, and an associated memory device. Although the use of the sulfite sensors 330 are described herein, the measurement of the sulfite may be made by other means such as on-line or periodic chemical analysis or other methods to provide the sulfite signal. The use of a sensor that provides specific on-line sulfite readings currently may be preferred. The use of the term sulfite “detector” thus is intended to cover the “sensor” and all of these different detection methods.

The control device 340 may compare the measured sulfite concentration(s) to one or more predetermined sulfite concentration values as a set point, which may be stored in the memory device. It is contemplated that the one or more predetermined sulfite concentration potential values may include a single value or a range of values. The predetermined value(s) may be a user-input parameter. For example, the predetermined sulfite concentration values may range from about 10 to 50 mg/L, about 20 to 50 mg/L, about 10 to 40 mg/L, about 5 to 75 mg/L, about 1 to 200 mg/L or about 1 to 400 mg/L. Other sulfite concentration values may be used herein. By “predetermined,” it is simply meant that the value is determined before the comparison is made with the actual measured sulfite concentration(s) as measured by the sulfite sensors 330.

Comparison of the measured sulfite concentration to the one or more predetermined sulfite concentration values may cause the control device 340 to provide a control signal to a valve and/or a blower 360. The valve and/or the blower 360 may adjust an amount of oxidation air 370 that is introduced from a fluidly connected oxidation air source 380 into the aqueous alkaline slurry 260 collected in the collection tank 310. Adjusting the amount of oxidation air 370 introduced to the collecting tank 310 may adjust the sulfite concentration of the aqueous alkaline slurry 260 present therein. The sulfite concentrations may range from about 10 to 50 mg/L, about 20 to 50 mg/L, about 10 to 40 mg/L, about 5 to 75 mg/L, about 1 to 200 mg/L, about 1 to 400 mg/L, and the like. Other sulfite concentrations may be used herein.

By comparing the measured sulfite concentration to the predetermined sulfite concentration values, the sulfite concentration may be adjusted as desired via the oxidation air 370. As such, it is possible to limit the overall concentration of mercury in the waste water 140 via the control of the sulfite concentrations. It is contemplated that the control device 340 may employ known control algorithms, e.g., proportional, integral, and/or derivative control algorithms, to adjust the control signals in response to the comparison of the measured sulfite concentration and the predetermined sulfite concentration values. Feed forward control schemes also may be used that incorporate other operating parameters available digitally as input to the control device 340 such as inlet SO₂ concentrations, a measure of the gas flow rate or other boiler operating condition such as percent load, and/or other operating conditions. Once treated, the WFGD system 130 produces a volume of the waste water140 that is forwarded to the WWTS 105 for further processing. An additional separator 390 and the like also may be used to reduce and/or classify by size the suspended solids in the stream sent to the WWTS 105. Other components and other configurations may be used herein.

The WFGD system 130 thus preconditions the flow of the waste water 140 to provide a more steady and consistent chemistry for the waste water 140 stream in the WWTS 105. Such consistency may improve overall WWTS 105 operation. For example, the chemical volumes may be decreased so as to provide reduced overall operating costs and reduced component size and/or capacity. Further, operation of bioreactor 460 is improved by not exposing the organisms to high ORP or oxidant or chlorine equivalent concentrations.

In a first trial, ORP levels were measured in a coal fired power plant with a WFGD system. The scrubbers in this plant normally operate with a constant supply of air to their slurry tanks. The nominal suspended solids concentration of the slurry is 15%. Dibasic acid is added to the WFGD system in a range from 200 to 300 ppm. The slurry tank in one of five absorbers connected to a common dewatering and liquid fraction recirculation system was used for the test. A sulfite analyzer was placed in a sink outside of this slurry tank. A continuous flow of slurry was drawn from the slurry tank and passed through the sink. ORP in the slurry varied during the course of one week of observation prior to the trial from about +250 to greater than +600 mV. During the trial, the aeration rate in the slurry tank was adjusted by a controller based on measurements from the sulfite analyzer for 12-14 hours per day. The controller was programed to maintain a sulfite concentration in the slurry tank of 20 mg/l. Actual sulfite concentrations produced by the controller ranged from about 10-30 mg/L. ORP levels during the trial varied in a range from +140 to +220 mV.

The total selenium concentration in the wastewater decreased by about 25% when the WFGD system was operated with sulfite monitoring and aeration control compared to when the WFGD system was operated without sulfite monitoring and aeration control.

In a second trial at another coal fired power plant with a WFGD system, ORP levels with a constant supply of air to the slurry tank varied from about +550 to greater than +700 mV. Operating the WFGD system of the second plant with sulfite level in the slurry tank controlled to a target of 30 mg/l resulted in ORP levels in a range from +125 to +153 mV. The total selenium concentration in the wastewater decreased by about 50% when the WFGD system was operated with sulfite monitoring and aeration control.

The foregoing describes only to certain embodiments of the present application and the resultant patent. Numerous changes and modifications may be made herein by one of ordinary skill in the art without departing from the general spirit and scope of the invention as defined by the following claims and the equivalents thereof.

1. A slurry treatment system for treating a slurry used in a wet flue gas desulfurization system having a tank to receive slurry that has previously contacted the flue gas and a separator to produce a liquid fraction of the slurry, the slurry treatment system comprising:
a sulfite control system configured to adjust a rate of oxygen addition to the slurry in an amount sufficient to produce one or more of a) a sulfite concentration in the slurry in the range of about 5 to 75 mg/L and b) an oxidation reduction potential in the range of about 100-250 mV; and,
an anoxic or anaerobic fixed bed biological reactor.

2. The slurry treatment system of claim 1 wherein the sulfite control system is configured to adjust a rate of oxygen addition to the slurry in an amount sufficient to produce a sulfite concentration in the slurry in the range of about 20 to 50 mg/L.

3. The slurry treatment system of claim 1 wherein the sulfite control system is configured to adjust a rate of oxygen addition to the slurry in an amount sufficient to produce a sulfite concentration in the slurry in the range of about 10 to 40 mg/L.

4. The slurry treatment system of claim 1 wherein the sulfite control system is configured to maintain a predetermined range of concentration of sulfite in the slurry or adjust the concentration of sulfite in the slurry to approach a predetermined concentration of sulfite in the slurry.

5. The slurry treatment system of claim 1 wherein the sulfite control system comprises a sulfite detector.

6. The slurry treatment system of claim 1 wherein the sulfite control system comprises a variable speed oxygen blower or a controlled valve.

7. The slurry treatment system of claim 1 wherein the reactor comprises an attached growth of selenium reducing organisms.

8. The slurry treatment system of claim 1 comprising a programmed controller connected to a sulfite detector and a variable speed oxygen blower and/or a controlled valve.

9. The slurry treatment system of claim 8 wherein the programmed controller controls the valve and/or the blower based upon the concentration of sulfite in slurry in or flowing into the tank.

10. The slurry treatment system of claim 1 one or more solid-liquid separation devices and one or more reagent mixers between the tank and the reactor.

11. A method of treating a slurry produced during desulfurization of a flue gas, comprising the steps of:
adding oxygen to the slurry in an amount sufficient to produce one or more of a) a sulfite concentration in the slurry in the range of about 5 to 75 mg/L and b) an oxidation reduction potential in the range of about 100-250 mV; and,
biologically converting soluble selenium species in a liquid fraction of the slurry to elemental selenium.

12. The method of claim 11 comprising adding oxygen to the slurry in an amount sufficient to produce a sulfite concentration in the range of about 20 to 50 mg/L.

13. The method of claim 11 comprising adding oxygen to the slurry in an amount sufficient to produce a sulfite concentration in the range of about 10 to 40 mg/L.

14. The method of claim 11 comprising a step of maintaining a predetermined range of concentration of sulfite in the slurry or adjusting the concentration of sulfite in the slurry to approach a predetermined concentration of sulfite in the slurry.

15. The method of claim 11 comprising measuring the sulfite concentration of the slurry or the sulfite concentration of an influent to the slurry.

16. The method of claim 15 comprising adjusting a rate of oxygen addition to the slurry in response to the measurement.

17. The method of claim 11 comprising treating the liquid fraction with an attached growth in a fixed bed reactor.

18. The method of claim 17 wherein the liquid fraction is sent to the reactor without intervening sulfite addition.

19. The method of claim 11 comprising treating the flue gas in a wet flue gas desulfurization system.
